(19) United States
(12) Patent Application Publication
(10) Pub. No.: US 2018/0181936 A1
(43) Pub. Date: Jun. 28, 2018

(54) REGISTER SYSTEM AND CONTROL METHOD THEREOF

(71) Applicant: TOSHIBA TEC KABUSHIKI KAISHA, Tokyo (JP)

(72) Inventors: Tsuyoshi GOTANDA, Ota Tokyo (JP); Takashi NAKAJIMA, Ota Tokyo (JP); Akiko SUSAKI, Ota Tokyo (JP)

(21) Appl. No.: 15/848,954

(22) Filed: Dec. 20, 2017

(30) Foreign Application Priority Data
Dec. 22, 2016 (JP) 2016-249570

(51) Int. Cl. G06Q 20/20; G07G 1/06; G07G 1/00; G07G 1/12; G07D 1/06; G06F 3/0488

(52) U.S. Cl. CPC G06Q 20/204; G06Q 20/201; G06Q 20/209; G07G 1/06; G06F 9/4443; G07G 1/12; G07D 1/06; G06F 3/0488; G07G 1/0027

(57) ABSTRACT

According to one embodiment, a register system includes a main body, a first touch panel on a first side of the main body, a second touch panel on a second side of the main body that is on an opposite side of the main body with respect to the first side, a change machine on the second side of the main body, and a control circuit to configured to display a first user interface on the first touch panel and a second user interface on the second touch panel. The control circuit including a change machine interface through which the control circuit transmits to the change machine a single instruction containing a change amount to dispense in response to more than one confirmation input being made through the first user interface.

### CROSS-REFERENCE TO RELATED APPLICATION

This application is based upon and claims the benefit of priority from Japanese Patent Application No. 2016-249570, filed Dec. 22, 2016, the entire contents of which are incorporated herein by reference.

### FIELD

Embodiments described herein relate generally to a register system and a control method thereof.

### BACKGROUND

In a semi-self-service transaction register, registration of a transaction's contents is performed by a clerk. After the clerk completes the registration of transaction contents, the clerk performs an operation to begin a customer's payment processing, and the transaction register is then readied to receive the customer's payment by insertion of cash into the transaction register. When cash is inserted by the customer, the transaction register counts and stores the inserted cash amount. The transaction register then settles the transaction according to the tendered amount, when the customer provides an instruction to settle the transaction and the tendered amount is at least equal to the total payment amount due according to the registered transaction.

However, in some instances, the customer may desire to change the transaction contents (add or subtract registered checkout items) after the process of cash insertion has been started. For example, there may be a case where the customer finds out that the total amount due is greater than the amount of cash in hand and therefore may wish to cancel the purchase of some of items previously registered by the clerk.

To cope with such a possibility, the transaction register may have a function of cancelling the processing for acquisition of cash and allowing the registration/modification of the present transaction's contents. The transaction register thus pays out cash that was deposited before the cancellation.

Thus, to settle the modified transaction, the customer would be required to begin the cash insertion process from the start.

In the circumstance described above, it would be preferable that time and effort required for cash re-insertion to meet the modified settlement amount for the altered transaction contents, be avoided when possible.

### DESCRIPTION OF THE DRAWINGS

FIG. 1 is a perspective view of a register system according to an embodiment.

FIG. 2 is a block diagram of main parts of the register system illustrated in FIG. 1.

FIG. 3 is a flowchart of information processing according to a first embodiment of the CPU of FIG. 2.

FIG. 4 is a diagram of an example operation screen.

FIG. 5 is a flowchart of information processing according to a second embodiment of the CPU of FIG. 2.

### DETAILED DESCRIPTION

According to one embodiment, a register system includes a main body, a first touch panel on a first side of the main body, a second touch panel on a second side of the main body that is on an opposite side of the main body with respect to the first side, a change machine on the second side of the main body, and a control circuit to configured to display a first user interface on the first touch panel and a second user interface on the second touch panel. The control circuit including a change machine interface through which the control circuit transmits to the change machine a single instruction containing a change amount to dispense in response to more than one confirmation input being made through the first user interface.

In the following, example embodiments will be described using accompanying drawings. These particulars relate to a case where a customer tenders payment associated with a commodity sales transaction.

### First Embodiment

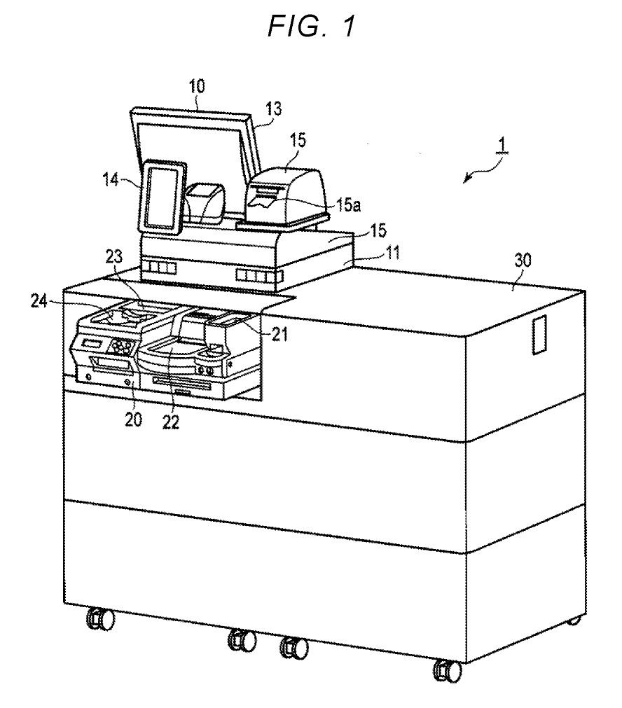

FIG. 1 is a perspective view of a register system according to an embodiment.

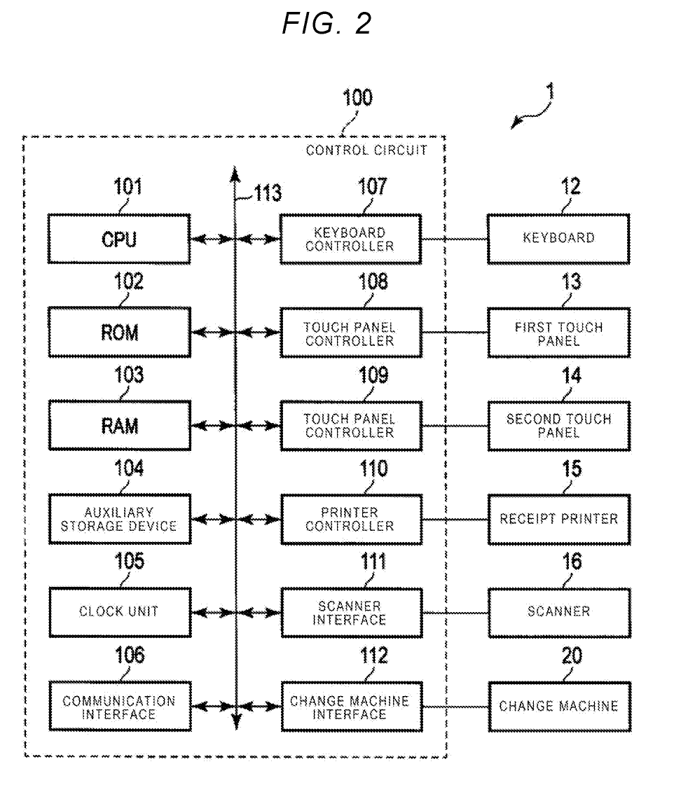

FIG. 2 is a block diagram of main parts of the register system.

As illustrated in FIG. 1, a register system 1 includes a point-of-sales (POS) terminal 10 and a change machine 20. The POS terminal 10 performs registration of commodity sales data. The change machine 20 receives cash payment and pays out change due. The POS terminal 10 is placed on a checkout counter 30. The change machine 20 is embedded in the checkout counter 30 in a state where a coin depositing port 21, a coin dispensing port 22, a bill depositing port 23, and a bill dispensing port 24 are exposed.

The checkout counter 30 partitions a work space for a clerk who operates the POS terminal 10 and a passage or lane through which a customer passes. In FIG. 1, a front side of the checkout counter 30 corresponds to a customer's passage and a back side opposite to the front side corresponds to a clerk's work space. As illustrated in FIG. 1, the checkout counter 30 is installed in such a way that the exposed coin depositing port 21, coin dispensing port 22, bill depositing port 23, and bill dispensing port 24 face the customer's passage.

The POS terminal 10 includes a main body 11 equipped with a control circuit 100 illustrated in FIG. 2 and various input and output devices such as a keyboard 12, a first touch panel 13, a second touch panel 14, a receipt printer 15, and the like that are provided on the main body 11. The keyboard 12 is illustrated in FIG. 2, but not specifically in FIG. 1.

The keyboard 12 is attached to the main body 11 and located within easy access from the clerk's work space.

The first touch panel 13 includes a display device such as a liquid crystal display and a touch sensor arranged on a display surface of the display device. The first touch panel 13 is attached to the main body 11 so that the display surface thereof is directed toward the clerk's work space side, thereby allowing the clerk to confirm information displayed on the display surface.

The second touch panel 14 includes a display device such as a liquid crystal display and a touch sensor on a display surface of the display device. The second touch panel 14 is attached to the main body 11 so that a display surface thereof is directed toward the customer's passage side, thereby allowing the customer to confirm information of the display surface. That is, the first touch panel 13 and the second touch panel 14 are disposed in an upper space of the checkout counter 30, in such a way that the display surfaces thereof are directed toward directions opposite to each other.

The receipt printer 15 prints receipt data using a printing head on a receipt paper roll and then outputs the printed receipt to a receipt issuing port 15a. The receipt printer 15 cuts printed receipt paper discharged from the receipt issuing port 15a by a cutter and issues the receipt. The receipt printer 15 is attached to the main body 11 so that the receipt issuing port 15a is directed to the customer's passage side, thereby allowing the customer to directly take the issued receipt.

The change machine 20 includes a coin safe storing coins by denominations and a bill safe storing bills by denominations. The change machine 20 acquires coins inserted into the coin depositing port 21, identifies denominations of the coins, and then stores the coins in the coin safe by denominations. The change machine 20 acquires bills inserted into the bill depositing port 23, identifies denominations of the bills, and then stores the bills in the bill safe by denominations. The change machine 20 discharges coins or bills stored in the coin safe or the bill safe from the coin dispensing port 22 or the bill dispensing port 24 according to a dispensing instruction from the POS terminal 10. Any known automatic change machine can be used as the change machine 20. The change machine 20 has functions corresponding to an acquisition unit and a paying out unit.

As illustrated in FIG. 2, the control 100 includes a central processing unit (CPU) 101, a read only memory (ROM) 102, a random access memory (RAM) 103, an auxiliary storage device 104, a clock unit 105, a communication interface 106, a keyboard controller 107, two touch panel controllers 108 and 109, a printer controller 110, a scanner interface 111, and a change machine interface 112. These elements are connected to a system transmission path 113 including an address bus, a data bus, and the like to configure the controller 100. Especially, the CPU 101, the ROM 102, the RAM 103, and the auxiliary storage device 104 are connected with the system transmission path 113 to configure a computer for controlling the POS terminal 10.

The CPU 101 corresponds to a central portion of the computer described above. The CPU 101 controls respective units so that various functions as the POS terminal 10 are implemented based on middleware and an application program stored in the ROM 102 and the RAM 103.

The ROM 102 corresponds to a main storage part of the computer described above. The ROM 102 stores the operating system described above. The ROM 102 may also store middleware or the application program described above. The ROM 102 may also store data that are referenced by the CPU 101 in performing various processing.

The RAM 103 corresponds to a main storage part of the computer. The RAM 103 stores data that are referenced by the CPU 101 in performing various processing. The RAM 103 stores data temporarily used in performing various processing by the CPU 101 and is utilized as a work area.

The auxiliary storage device 104 corresponds to an auxiliary storing part of the computer.

The auxiliary storage device 104 saves data used in performing various processing by the CPU 101 or data generated by processing in the CPU 101. As the auxiliary storage device 104, for example, an electrically erasable programmable read-only memory (EEPROM), a hard disc drive (HDD), a solid state drive (SSD), or the like is used.

The clock unit 105 functions as a time information source of the POS terminal 10. The communication interface 106 performs data communication with an external device such as a server connected through a communication network such as a local area network (LAN), according to a communication protocol.

The keyboard controller 107 controls the keyboard 12 and acquires a key signal corresponding to a key pressed from the keyboard 12.

The touch panel controller 108 controls display on the display device of the first touch panel 13. The touch panel controller 108 detects a touch position coordinates on the screen in the display device of the first touch panel 13 by a signal from a touch sensor of the first touch panel 13.

The touch panel controller 109 controls display on the display device of the second touch panel 14. The touch panel controller 109 detects a touch position coordinates on the screen in the display device of the second touch panel 14 by a signal from a touch sensor of the second touch panel 14.

The printer controller 110 outputs receipt printing data to the receipt printer 15 and controls issuing of a receipt.

The scanner interface 111 connects the control circuit 100 to a scanner 16 which optically reads a code symbol such as a barcode or a two-dimensional data code. The scanner interface 111 sends and receives a data signal for the scanner 16 to thereby acquire data of the code symbol read by the scanner 16. The scanner 16 may be a stationary scanner and may also be a handy type scanner.

The change machine interface 112 connects the control circuit 100 to the change machine 20. The change machine interface 112 sends and receives a data signal for the change machine 20 to thereby acquire data relating to the amount of cash inserted into the change machine 20 from the change machine 20. The change machine interface 112 transmits data related to dispensing of money such as money data to the change machine 20 and controls dispensing of money from the change machine 20.

Next, operations of the register system 1 configured as described above will be described.

The register system 1 has a plurality of job modes that are generally the same as those in an existing transaction register device. In a job mode for accounting processing, which is one of the possible job modes, when the register system 1 is activated, the CPU 101 starts information processing according to an application program stored in the ROM 102 or the auxiliary storage device 104. The particulars of the information processing are merely one example and various other processing steps can be utilized to obtain the same result.

When the register system 1 is transferred to another user, the application program is typically stored in the ROM 102 or the auxiliary storage device 104. However, an application program may be provided separately from the register system 1 and written to the auxiliary storage device 104 of the register system 1 after the transfer. In this case, the application program separately provided may be of a same kind but of a different version from the application program originally stored in the register system 1. Such an application program may not be provided at all. In the former case, the application program separately provided and written into the auxiliary storage device 104 of the register system 1 is utilized, instead of the application program originally stored in the register system 1. At the time of transfer, an application program can be provided in a removable recording medium such as a magnetic disk, a magneto-optical disk, an optical disk, or a semiconductor memory or performing communication through a network.

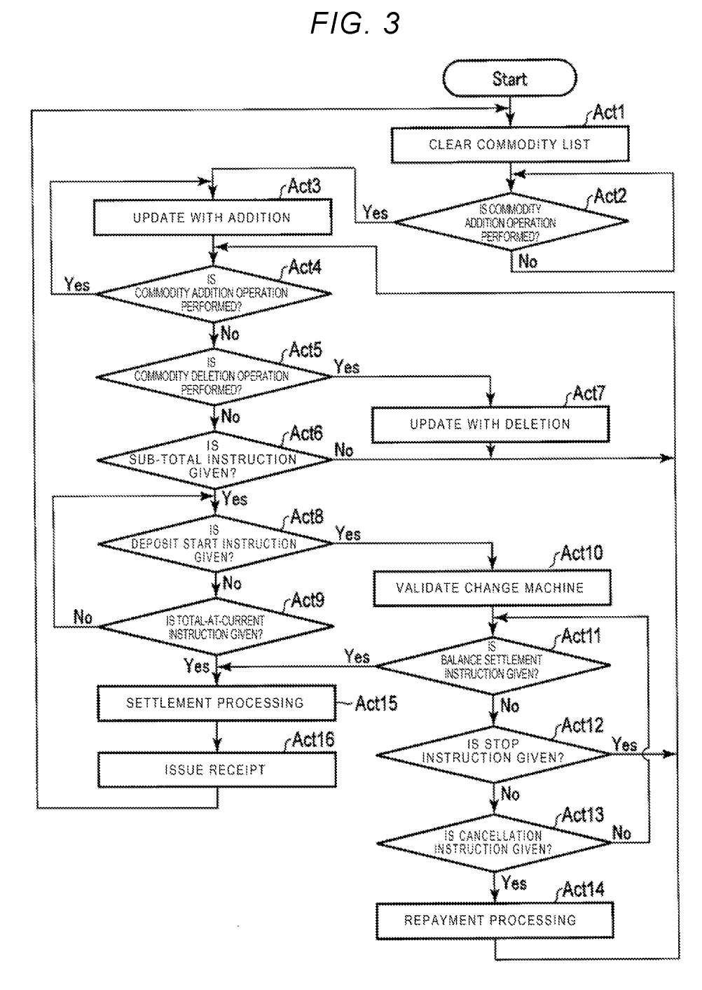

FIG. 3 is a flowchart of information processing of the CPU 101 according to a first embodiment.

As processing of Act1, the CPU 101 clears a commodity list previously stored in the RAM 103 or the auxiliary storage device 104.

As processing of Act2, the CPU 101 waits for a commodity addition operation for adding a commodity being purchased to a commodity list. For example, when a predetermined operation such as reading of the barcode on the commodity (using the scanner 16) is performed, the CPU 101 determines that a determination result is “Yes” and proceeds to Act3. As processing of Act3, the CPU 101 updates the commodity list so that the commodity code input by the commodity addition operation is added to the commodity list.

As processing of Act4, the CPU 101 confirms whether the commodity addition operation has been performed or not. When it is determined that the commodity addition operation has not been performed, the CPU 101 determines that a determination result is “No” and proceeds to Act5.

As processing of Act5, the CPU 101 confirms whether a commodity deletion operation for deleting a commodity on the commodity list has been performed or not. When it is determined that the commodity deletion operation has not been performed, the CPU 101 determines that a determination result is “No” and proceeds to Act6.

As processing of Act6, the CPU 101 confirms whether a sub-total instruction has been given or not. When it is determined that the sub-total instruction has not been given, the CPU 101 determines that a determination result is “No” and returns to Act4.

As such, the CPU 101 waits for any of the commodity addition operation, the commodity deletion operation, and the sub-total instruction in Act4 to Act6. When the commodity addition operation is performed, the CPU 101 executes processing as Act3 again. When one of the commodities is selected and then a commodity deletion operation is performed using, for example, the keyboard 12, the CPU 101 determines that a determination result in Act5 is “Yes” and proceeds to Act7.

As processing of Act7, the CPU 101 updates the commodity list so that a commodity for which an instruction to delete is given is deleted. After that, the CPU 101 returns to a waiting state of Act4 to Act6.

The clerk performs the commodity addition operation and the commodity deletion operation as needed and as a result, the commodities that are to be purchased are reflected in the commodity list. In this commodity registration state, contents of the transaction can be registered. By doing this, processing as Act2 to Act5 and Act6 corresponds to registering contents of the transaction which is a settlement target. That is, the CPU 101 executes information processing based on the application program performed by the CPU 101 of the computer, which function as a registration unit.

When the commodity list reflects the commodities that are to be purchased, the clerk gives a sub-total instruction using the keyboard 12 or the first touch panel 13. Then, the CPU 101 determines that a determination result in Act6 is “Yes” and proceeds to Act8.

As processing of Act8, the CPU 101 confirms whether a deposit start instruction has been given or not. When it is determined that the deposit start instruction has not been given, the CPU 101 determines that a determination result is “No” and proceeds to Act9.

As processing of Act9, the CPU 101 confirms whether a grand-total instruction has been given or not. When it is determined that the grand-total instruction has not been given, the CPU 101 determines that a determination result is “No” and returns to Act8.

By doing this, the CPU 101 waits for the deposit start instruction or the grand-total instruction in Act8 and Act9.

When the customer desires to settle a transaction in cash and desires to use the change machine 20, the clerk gives a deposit instruction using the keyboard 12 or the first touch panel 13. Then, the CPU 101 determines that a determination result in Act8 is “Yes” and proceeds to Act10.

As processing of Act10, the CPU 101 validates the change machine 20. The change machine 20 is then capable of receiving cash. When the customer inserts coins and bills into the coin depositing port 21 and the bill depositing port 23, the change machine 20 acquires the coins and bills, and counts the tendered amount.

As processing of Act11, the CPU 101 confirms whether a balance settlement instruction has been given or not. When it is determined that the balance settlement instruction has not been given, the CPU 101 determines that a determination result is “No” and proceeds to Act12.

As processing of Act12, the CPU 101 confirms whether a stop instruction has been given or not. When it is determined that the stop instruction has not been given, the CPU 101 determines that a determination result is “No” and proceeds to Act13.

As processing of Act13, the CPU 101 confirms whether a cancellation instruction has been given or not. When it is determined that the cancellation instruction has not been given, the CPU 101 determines that a determination result is “No” and proceeds to Act11. By doing this, the CPU 101 waits until the balance settlement instruction, the stop instruction, and the stop instruction are given in Act11 to Act13.

For example, when the change machine 20 can receive inserted coins and bills, the CPU 101 causes an operation screen on the second touch panel 14 to display selections for the customer.

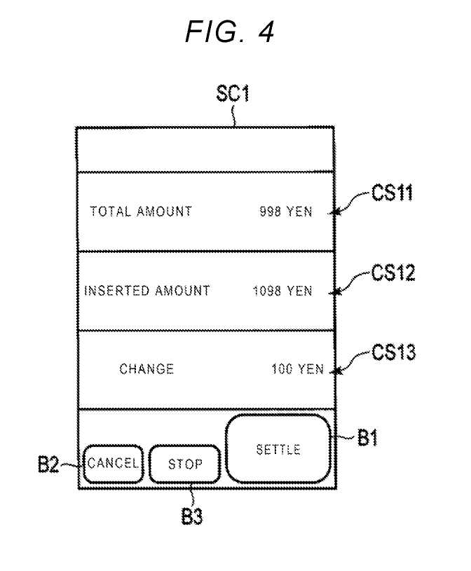

FIG. 4 illustrates an operation screen SC1 as an example of the operation screen on the second touch panel 14.

The operation screen SC1 includes character strings CS11, CS12, and CS13 and buttons B1, B2, and B3. The character string CS11 represents an amount due (referred to as a total amount) to be paid, that is, a settlement amount. The character string CS12 represents a tendered amount at the present time. The character string CS13 represents a change due if the transaction is settled without further changes. The button B1 is a button for instructing a balance settlement. The button B2 is a button for instructing a cancellation. The button B3 is a button for instructing a stop.

If the customer intends to settle the transaction by the tendered amount at the present time, the customer touches the button B1. That is, touching the button B1 is an example of the settlement operation. If the customer intends to invalidate the tendered amount (referred to as an inserted amount) at the present time and return to the commodity registration state, the customer touches the button B2. That is, touching the button B2 is an example of the cancellation operation. If the customer intends to hold a cash insertion state at the present time and return to the commodity registration state, the customer touches the button B3. That is, touching the button B3 is an example of the stop operation. If the tendered amount is less than the amount due, the CPU 101 may invalidate touching on the button B1 or may cause the button B1 not to be displayed.

When the button B2 is touched, the CPU 101 determines that a determination result in Act13 is “Yes” and proceeds to Act14.

As processing of Act14, the CPU 101 performs repayment processing. Specifically, the CPU 101 causes the tendered amount at the present to be paid out from the change machine 20 and clears the tendered amount counted by the change machine 20 to zero. Thereafter, the CPU 101 returns to a waiting state of Act4 to Act6, that is, the commodity registration state.

When the CPU 101 is in the waiting state of Act11 to Act13, if the button B3 is touched, the CPU 101 determines that a determination result in Act12 is “Yes”. In this case, the CPU 101 skips Act14 and returns to the waiting state of Act4 to Act6. That is, the CPU 101 returns to the commodity registration state without paying out the tendered amount and while holding the tendered amount counted by the change machine 20. By this process, the CPU 101 executes information processing based on the application program performed by the CPU 101 of the computer, which functions as a resumption control unit for resuming registration processing while holding the tendered amount.

If the button B1 is touched when the CPU 101 is in the waiting state of Act11 to Act13, the CPU 101 determines that a determination result in Act11 is “Yes” and proceeds to Act15. In a case where the grand-total instruction has been given when the CPU 101 is in the waiting state of Act8 and Act9, the CPU 101 determines that a determination result in Act9 is “Yes” and in this case, the CPU 101 proceeds to Act15 as well.

As processing of Act15, the CPU 101 performs settlement processing. Specifically, in a case where the CPU 101 proceeds from Act11 to Act15, the CPU 101 subtracts the price from the tendered amount counted by the change machine 20 to calculate a change due. In a state where the cash insertion state is held to the present time, and the operations are performed in the order of the “commodity registration”, the “sub-total instruction”, and the “deposit start instruction”, the change machine 20 is then capable of receiving additional insertion of cash. In this state, when the customer inserts additional cash, the additional amount is added to the tendered amount. The price is subtracted from a total tendered amount to calculate a change due. That is, an amount of cash including the additional amount of cash until the balance settlement instruction is given from the end of resumed registration processing is regarded as a tendered amount and the transaction is settled by the tendered amount. By this process, the CPU 101 executes information processing based on the application program performed by the CPU 101 of the computer, which functions as a settlement unit. In a case where the CPU 101 proceeds from Act9 to Act15, the CPU 101 subtracts the price from the tendered amount input by the clerk at the time when the grand-total instruction is given to calculate a change due. When change due is calculated, the CPU 101 discharges the change due from the change machine 20. In a case where the CPU 101 proceeds from Act9 to Act15, the CPU 101 may discharge the change due to the change machine separately connected to the POS terminal 10 and directed to the clerk's side or may cause a cash drawer separately connected to the POS terminal 10 and directed to the clerk's side to be open. In a state where the cash insertion state is held to the present time, and the operations are performed in the order of the “commodity registration” and the “sub-total instruction”, the CPU 101 may not receive the grand-total instruction. In this case, the CPU 101 may wait for the deposit start instruction and may automatically determine that a determination result is “Yes” in Act8.

As processing of Act16, the CPU 101 issues a receipt. Specifically, the CPU 101 generates receipt printing data in which contents of the transaction, settlement results, and the like are listed and instructs the receipt printer 15 to print the receipt image.

Thereafter, the CPU 101 returns to Act1 and prepares for starting of accounting for a next transaction.

As described above, according to the register system 1, even after insertion of cash into the change machine 20 is started, the customer touches the button B3 to thereby make it possible to return to the commodity registration state while holding the state of cash insertion into the change machine 20. Thereafter, when the clerk gives the deposit start instruction again, the customer is able to continue cash insertion from the held cash insertion state. In a case where the customer touches the button B2 after starting cash insertion into the change machine 20, after the tendered amount is paid out from the change machine 20, the CPU returns to the commodity registration state. Accordingly, when the clerk gives the deposit start instruction again thereafter, the customer has to try insertion of cash to the change machine 20 from the start. For that reason, in a case where the customer intends to add a commodity to purchase or delete a commodity from a commodity list after starting cash insertion into the change machine 20, the customer touches the button B3 to thereby make it possible to reduce time and labor required for subsequent of cash insertion.

According to the register system 1, the customer touches the button B2 to thereby make it possible to invalidate the tendered amount and re-start subsequent cash insertion into the change machine 20.

### Second Embodiment

The configuration of main parts of hardware of the register system 1 for operations according to a second embodiment may be the same as those according to the first embodiment. The difference in the operations between the first embodiment and the second embodiment is contents of the application program stored in the ROM 102 or the auxiliary storage device 104. Accordingly, the difference between the first embodiment and the second embodiment is the information processing to be performed by the CPU 101 based on the application program.

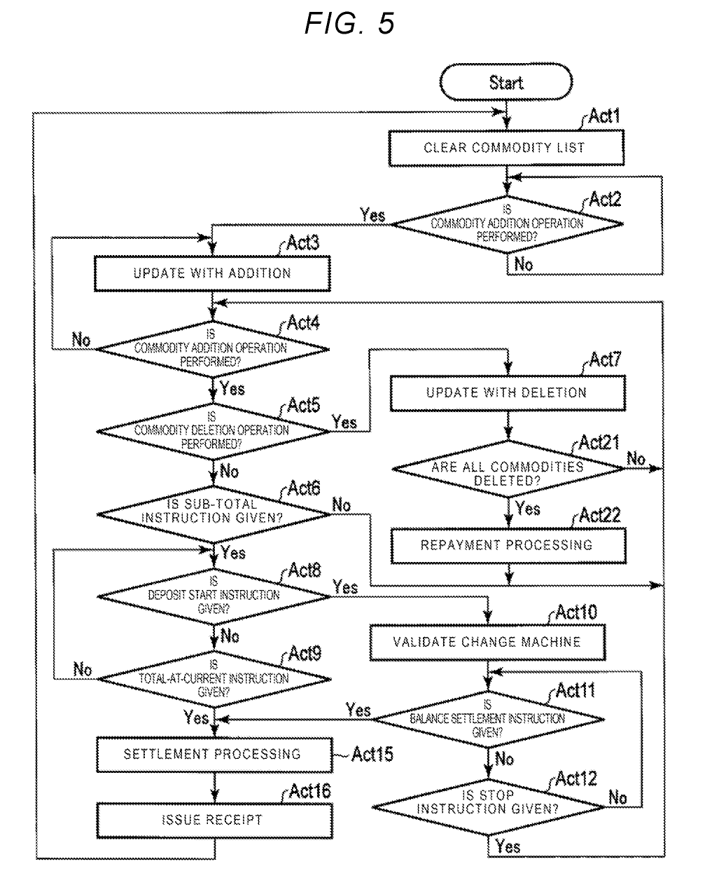

FIG. 5 is a flowchart of information processing of the CPU 101 according to the second embodiment based on the application program. The same reference numerals are used for the operations that are substantially the same as those in FIG. 3, and the description of repeated operations may be omitted.

In the second embodiment, for Act1 to Act12, the CPU 101 performs the operations that are substantially the same as those in the first embodiment. When it is determined that a determination result in Act12 is “No”, the CPU 101 does not proceed to Act13 and returns to Act11. That is, in Act11 and Act12, the CPU 101 waits for the balance settlement instruction and the stop instruction and does not wait for the cancellation instruction. For that reason, the CPU 101 omits displaying the button B2 illustrated in FIG. 4 to be omitted in a screen on the second touch panel 14 in the waiting state.

According to the second embodiment, after the commodity list is updated so that a commodity for which a deletion operation is given in Act7 is deleted, the CPU 101 does not return to the waiting state of Act4 to Act6 as in the first embodiment, but proceeds to Act21.

As processing of Act21, the CPU 101 confirms whether all commodities subjected to sales transaction so far have been deleted or not. Specifically, the CPU 101 confirms whether any one of the commodity codes is included in the commodity list or not. When any one of the commodity codes is included in the commodity list, the CPU 101 determines that a determination result is “No” and returns to the waiting state of Act4 to Act6. However, when any one of the commodity codes is not included in the commodity list, the CPU 101 determines that a determination result in Act21 is “Yes” and proceeds to Act22.

As processing of Act22, the CPU 101 performs repayment processing. Specifically, the CPU 101 confirms whether the tendered amount counted in the change machine 20 is zero or not. When it is confirmed that the tendered amount is not zero, the CPU 101 causes the change machine 20 to pay out cash corresponding to the tendered amount and clears the tendered amount counted by the change machine 20 to zero. When the tendered amount counted in the change machine 20 is zero, the CPU 101 ends Act22 as it is. Thereafter, the CPU 101 returns to the waiting state of Act4 to Act6. However, in this case, the CPU 101 may return to the waiting state of Act2.

As such, the CPU 101 causes the change machine 20 to pay out the tendered amount according to the fact that the amount due to be settled is zero due to no commodity registered in the commodity list. By doing this, the CPU 101 executes information processing based on the application program performed by the CPU 101 of the computer, which functions as a paying out control unit.

That is, in a case where it is returned to the commodity registration state after cash insertion is started, the customer is able to select whether to repay cash at that time or hold the cash insertion state in the first embodiment, while the customer has to hold the cash insertion state in the second embodiment. According to the second embodiment, repaying of the tendered amount is automatically performed when all commodities registered in the commodity list are deleted by the commodity deletion operation performed in the commodity registration state which is returned as described.

By doing this, as long as the customer deletes commodities in the commodity list or add commodities to be purchased to the commodity list, the customer is able to continue to insert cash without giving further instructions and is able to reduce time and labor required before cash insertion.

In the operations according to the second embodiment, in a case where it is returned to the commodity registration state after cash insertion is started, the customer does not need to depress the buttons B2 and B3 as in the first embodiment and the operation becomes easy compared to the first embodiment. However, according to the second embodiment, it is unable to perform repayment of cash corresponding to the tendered amount at the time of returning to the commodity registration state, and thus the operations according to the first embodiment provides a more flexible operation according to customer's needs.

The operations according to the second embodiment can be modified in the following.

It is also possible to execute information processing according to the second embodiment by adding Act21 and Act22 illustrated in FIG. 5 without omitting Act13 illustrated in FIG. 3 in the first embodiment. By doing as such, in a case where it is returned to the commodity registration state after cash insertion is started, the customer is able to select as in the first embodiment whether cash is to be repaid at that time or not. Furthermore, in a case where the customer selects to hold the cash insertion state, repaying of cash corresponding to the tendered amount is automatically performed when all commodities in the commodity list are deleted.

The register system can as also be a self-service register system configured to allow a customer to perform the commodity addition operation. In this case, the self-service register system may or may not receive a commodity deletion operation by a customer. In a case where the self-service register system does receive the commodity deletion operation by the customer, Act5 and Act7 in FIG. 3 or FIG. 5 may be omitted, Act5 and Act7 may remain in FIG. 3 or FIG. 5 as Act5 and Act7 the commodity deletion operation by the clerk.

The transaction, also referred to as a settlement target, is not limited to sales of a commodity and may be any transaction, for example, receiving and delivering of service or the like.

Some or all of respective functions performed by control processing by the CPU 101 can also be performed by hardware such as a logic circuit that executes information processing without a computer program. Each of the functions can also be performed by combining hardware such as the logic circuit with software control.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A register system comprising:
a main body;
a first touch panel on a first side of the main body;
a second touch panel on a second side of the main body that is on an opposite side of the main body with respect to the first side;
a change machine on the second side of the main body; and
a control circuit to configured to display a first user interface on the first touch panel and a second user interface on the second touch panel, the control circuit including a change machine interface through which the control circuit transmits to the change machine a single instruction containing a change amount to dispense in response to more than one confirmation input being made through the first user interface.

2. The register system according to claim 1, wherein an option is selected through the second user interface in between two confirmation inputs made through the first user interface.

3. The register system according to claim 2, wherein the change amount to dispense is computed based on a first value associated with the last confirmation input and a second value received through the change machine interface from the change machine.

4. The register system according to claim 3, wherein the second value is received after a first of the confirmation inputs and before a second of the confirmation inputs.

5. The register system according to claim 3, wherein the second value is received after two of the confirmation inputs.

6. The register system according to claim 3, wherein the control circuit is configured to display the first and second values on the second user interface.

7. The register system according to claim 6, wherein the control circuit transmits the single instruction to the change machine in response to another option selected through the second user interface.

8. A register system comprising:
a point-of-sales terminal including a control circuit;
a change machine; and
a receipt printer,
wherein the controller is configured to:
register items in a sales transaction for a customer,
track an amount of cash deposited in the change machine by the customer,
when a stop instruction is given, allow the customer to modify the items in the sales transaction while holding the cash in the change machine,
calculate an amount to be tendered by the customer by comparing the cash already deposited in the cash machine by the customer to a total payment amount due in the sales transaction according to the modified items in the sales transaction.

9. The system according to claim 8, wherein the controller is further configured to:
in response to a cancellation instruction given before the sales transaction is finally completed, pay out all cash that was deposited in the change machine by the customer.

10. The system according to claim 8, wherein the controller is further configured to:
pay out all cash that was deposited in the change machine by the customer when a total payment amount due according to the registered sales transaction is zero.

11. The system according to claim 8, wherein the controller restricts a customer from registering items in a sales transaction.

12. The system according to claim 8, wherein the controller allows a customer to register items in a sales transaction.

13. The system according to claim 12, wherein the controller restricts a customer to delete an item from the registered sales transaction.

14. The system according to claim 8, wherein the receipt printer prints a sales transaction receipt when the sales transaction has been completed.

15. A method for controlling a register system including a main body, a first touch panel on a first side of the main body, a second touch panel on a second side of the main body that is on an opposite side of the main body with respect to the first side, and a change machine on the second side of the main body, said method comprising:
displaying a first user interface on the first touch panel and a second user interface on the second touch panel; and
transmitting to the change machine a single instruction containing a change amount to dispense in response to more than one confirmation input being made through the first user interface.

16. The method according to claim 15, wherein an option is selected through the second user interface in between two confirmation inputs made through the first user interface.

17. The method according to claim 16, wherein the change amount to dispense is computed based on a first value associated with the last confirmation input and a second value received from the change machine.

18. The method according to claim 17, wherein the second value is received after a first of the confirmation inputs and before a second of the confirmation inputs.

19. The method according to claim 17, wherein the second value is received after two of the confirmation inputs.

20. The method according to claim 17, further comprising:
displaying the first and second values on the second user interface.
